(19) United States
(12) Patent Application Publication
(10) Pub. No.: US 2014/0278734 A1
(43) Pub. Date: Sep. 18, 2014

(54) RISK SCREENING TOOL

(71) Applicant: BAKER ENGINEERING & RISK CONSULTANTS, INC, San Antonio, TX (US)

(72) Inventors: William A. Mather, Katy, TX (US); Brian Harvey, Missouri City, TX (US); Jeffrey R. Rowley, Houston, TX (US)

(21) Appl. No.: 14/216,057

(22) Filed: Mar. 17, 2014

Related U.S. Application Data
(60) Provisional application No. 61/802,793, filed on Mar. 18, 2013.

(51) Int. Cl. G06Q 10/06

(52) U.S. Cl. CPC G06Q 10/0635
USPC 705/7.28

(57) ABSTRACT

Systems and methods for computerized risk screening are provided. A plurality of facilities are identified for analysis of risk at each facility in the plurality of facilities. For each facility in the plurality of facilities, an answer set to a questionnaire is received. The answer set includes answers to questions for analysis of the risk at the facility. For each facility in the plurality of facilities, a predicted risk level of the risk at the facility is determined based on the answer set. A visual interface is provided. The visual interface includes: (i) a list of at least a portion of the facilities from among the plurality of facilities, (ii) a visual representation of at least one facility from among the plurality of facilities, and (iii) a visual indication of the predicted risk level of the risk for the at least one facility from among the plurality of facilities.

### CROSS REFERENCE TO RELATED APPLICATION

This application claims priority under 35 U.S. C. §119(e) and the benefit of U.S. Provisional Application No. 61/802,793, filed Mar. 18, 2013, and entitled, “TERMINAL TOOL,” the entire disclosure of which is incorporated herein by reference.

### TECHNICAL FIELD

The subject technology is generally directed to a predicting, using a computer, a risk level at a facility.

### BACKGROUND

Oftentimes, organizations such as businesses or governments have to manage multiple facilities located at multiple different geographic locations throughout the world. Keeping track of all of the facilities and allocating risk-management resources (e.g., inspectors, evacuations, urgent repairs or replacements, etc.) to appropriate facilities may be challenging. As the foregoing illustrates, a new approach for screening multiple facilities for a risk and identifying the facilities that are most prone to the risk may be desirable.

### SUMMARY

In some aspects, the disclosed subject matter relates to a computer-implemented method for risk screening. The method includes identifying, via one or more computing devices, a plurality of facilities for analysis of risk at each facility in the plurality of facilities. The method includes receiving, at the one or more computing devices, for each facility in the plurality of facilities, an answer set to a questionnaire, the answer set comprising answers to questions for analysis of the risk at the facility. The method includes determining, at the one or more computing devices, for each facility in the plurality of facilities, a predicted risk level of the risk at the facility based on the answer set. The method includes providing, via the one or more computing devices, a visual interface comprising: (i) a list of at least a portion of the facilities from among the plurality of facilities, (ii) a visual representation of at least one facility from among the plurality of facilities, and (iii) a visual indication of the predicted risk level of the risk for the at least one facility from among the plurality of facilities.

In some aspects, the disclosed subject matter relates to a non-transitory computer-readable medium encoded with executable instructions for risk screening. The instructions include code for identifying a plurality of facilities for analysis of risk at each facility in the plurality of facilities. The instructions include code for receiving, for each facility in the plurality of facilities, an answer set to a questionnaire, the answer set comprising answers to questions for analysis of the risk at the facility. The instructions include code for determining, for each facility in the plurality of facilities, a predicted risk level of the risk at the facility based on the answer set. The instructions include code for providing a visual interface comprising: (i) a list of at least a portion of the facilities from among the plurality of facilities, (ii) a visual representation of at least one facility from among the plurality of facilities, and (iii) a visual indication of the predicted risk level of the risk for the at least one facility from among the plurality of facilities.

In some aspects, the disclosed subject matter relates to a system for risk screening. The system includes one or more processors and a memory. The memory includes instructions. The instructions include code for identifying a plurality of facilities for analysis of risk at each facility in the plurality of facilities. The instructions include code for receiving, for each facility in the plurality of facilities, an answer set to a questionnaire, the answer set comprising answers to questions for analysis of the risk at the facility. The instructions include code for determining, for each facility in the plurality of facilities, a predicted risk level of the risk at the facility based on the answer set. The instructions include code for providing a visual interface comprising: (i) a list of at least a portion of the facilities from among the plurality of facilities, (ii) a visual representation of at least one facility from among the plurality of facilities, and (iii) a visual indication of the predicted risk level of the risk for the at least one facility from among the plurality of facilities.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Features of the subject technology are set forth in the appended claims. However, for purpose of explanation, several aspects of the disclosed subject matter are set forth in the following figures.

FIG. 1 illustrates an example process by which risk screening analysis may be implemented.

FIG. 2 illustrates a first example display associated with a computerized risk screening tool.

FIG. 3 illustrates a second example display associated with a computerized risk screening tool.

FIG. 4 illustrates a first example input prompt associated with a computerized risk screening tool.

FIG. 5 illustrates a second example input prompt associated with a computerized risk screening tool.

FIG. 6 illustrates a third example display associated with a computerized risk screening tool.

FIG. 7 illustrates an example summary display associated with a computerized risk screening tool.

FIG. 8 illustrates a fourth example display associated with a computerized risk screening tool.

FIG. 9 illustrates a fifth example display associated with a computerized risk screening tool.

FIG. 10 illustrates a sixth example display associated with a computerized risk screening tool.

FIG. 11 illustrates a seventh example display associated with a computerized risk screening tool.

FIG. 12 illustrates an example network system in which computerized risk screening may be implemented.

FIG. 13 is a block diagram illustrating the risk screening computer of FIG. 12 in greater detail.

FIG. 14 illustrates an example process by which computerized risk screening may be implemented.

FIG. 15 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent that the subject technology is not limited to the specific details set forth herein and may be practiced without these specific details. In some instances, certain structures and components are shown in block diagram form in order to avoid obscuring the concepts of the subject technology.

As set forth above, a new approach for screening multiple facilities for a risk and identifying the facilities that are most prone to the risk may be desirable. The subject technology provides, among other things, a computerized risk screening tool that screens multiple facilities for risk and identifies the facilities that are most prone to the risk. The risk may include one or more of a safety risk, an environmental impact risk, an asset damage risk, a business loss risk, a public image risk, or a public notification risk. A safety risk is a risk to the safety of people who are located in a geographic area (e.g., at the facility or within a certain radius (e.g., two kilometers or 10 kilometers) of the facility). An environmental impact risk is a risk of damaging the environment (e.g., air, water, nature, etc.) at or near the facility. An asset damage risk is a risk of damaging assets (e.g., vehicles, inventory, machinery, etc.) at or near the facility. A business loss risk is a risk of losing business due to an event (e.g., oil spill, large fire, etc.) associated with the risk. A public image risk is a risk of a business receiving a poor public image due to an event (e.g., oil spill, large fire, etc.) associated with the risk. A public notification risk is a risk of the public being notified of an associated event (e.g., oil spill, large fire, etc.).

According to some implementations, a computer identifies multiple facilities (e.g., factories, warehouses, storage locations, military bases, shipping stations, etc.) for analysis of risk at the multiple facilities. The computer receives, for each facility in the multiple facilities, an answer set to a questionnaire with questions for analysis of the risk at the facility. The computer determines a predicted risk level of the risk at each facility based on the received answer sets. The computer provides a visual interface that identifies a predicted risk level for at least one facility from the multiple facilities.

FIG. 1 illustrates an example process 100 by which risk screening analysis may be implemented. The process 100 may be implemented using one or more computers. The process 100 begins at step 105, where a new study is started. At step 110, a prescreening questionnaire is added. At step 115, facilities are added. Steps 120-130 include the initial prescreening. In step 120, the prescreening questionnaire for the facility is completed. In step 125, the one or more computers determine whether the prescreening score, from the prescreening questionnaire for a facility, exceeds acceptance criteria. If so, the process 100 continues to step 135. If not, then as noted in step 130, the facility prescreening is complete and the process 100 ends.

In step 135, if the prescreening score exceeds the acceptance criteria, the model is populated with one or more of a map, a building, a population, or a sensitive area (e.g., a highlighted area on the map that is particularly prone to the risk). In step 140, consequences are assigned to risk sources, and in step 145 the risk sources (e.g., storage vessels, pipelines or other equipment) are added to the map of the facility. In step 150, a detailed prescreening report, which may include a screen display or a printout of the map and the information added to the map. After step 150, the process 100 ends.

FIG. 2 illustrates a first example display associated with a computerized risk screening tool. As shown, the display in FIG. 2 illustrates a list of facilities (“Facility One” and “Facility Two”) at the left, a map of a facility at the center, and information about the risk value for the mapped facility at the right.

FIG. 3 illustrates a second example display associated with a computerized risk screening tool. The display of FIG. 3 allows the user to view and/or edit textual information about the facilities and to view a predicted risk value (“score”) for the facilities.

FIG. 4 illustrates a first example input prompt associated with a computerized risk screening tool. Using the input prompt of FIG. 4, a user may input information (e.g., name, description, comments or map) related to a facility. The input prompt of FIG. 4 may be presented at a computing device implementing the process described in conjunction with FIG. 14, below, or via another computer connected to that computing device via a network.

FIG. 5 illustrates a second example input prompt associated with a computerized risk screening tool. Using the input prompt of FIG. 5, a user may input information (e.g., name, consequence(s) or consequence severity information) related to equipment (e.g., a storage tank, a machine, etc.) at the facility. The input prompt of FIG. 5 may be presented at a computing device implementing the process described in conjunction with FIG. 14, below, or via another computer connected to that computing device via a network.

FIG. 6 illustrates a third example display associated with a computerized risk screening tool. Similar to FIG. 2, the display of FIG. 6 illustrates a list of facilities (“Facility One” and “Facility Two”) at the left, a map of a facility at the center, and information about the risk value for the mapped facility at the right. The map of FIG. 6 also includes a highlighted line indicating locations on the map that are particularly prone to (e.g., have a greater likelihood of) the risk.

FIG. 7 illustrates an example summary display associated with a computerized risk screening tool. The summary indicates the overall risk screening for each facility (“Facility One” and “Facility Two” in FIG. 7). Using the summary display, a user can quickly determine which facilities are most prone to the risk.

FIG. 8 illustrates a fourth example display associated with a computerized risk screening tool. Similar to FIG. 2, the display of FIG. 8 illustrates a list of facilities (“Facility One” and “Facility Two”) at the left, a map of a facility at the center, and information about the risk value for the mapped facility at the right. The map of FIG. 8 also includes multiple highlighted sections indicating locations on the map that are particularly prone to (e.g., have a greater likelihood of) the risk and have different risk value ranges. The display of FIG. 8 may correspond to a flammability hazard.

FIG. 9 illustrates a fifth example display associated with a computerized risk screening tool. Similar to FIG. 2, the display of FIG. 8 illustrates a list of facilities (“Facility One” and “Facility Two”) at the left, a map of a facility at the center, and information about the risk value for the mapped facility at the right. The map of FIG. 8 also includes multiple highlighted sections indicating locations on the map that are particularly prone to (e.g., have a greater likelihood of) the risk and have different risk value ranges. The display of FIG. 8 may correspond to a thermal radiation hazard.

FIG. 10 illustrates a sixth example display associated with a computerized risk screening tool. Similar to FIG. 2, the display of FIG. 8 illustrates a list of facilities (“Facility One” and “Facility Two”) at the left, a map of a facility at the center, and information about the risk value for the mapped facility at the right. The map of FIG. 8 also includes multiple highlighted sections indicating locations on the map that are particularly prone to (e.g., have a greater likelihood of) the risk and have different risk value ranges. The display of FIG. 8 may correspond to a toxicity hazard.

FIG. 11 illustrates a seventh example display associated with a computerized risk screening tool. Similar to FIG. 2, the display of FIG. 8 illustrates a list of facilities (“Facility One” and “Facility Two”) at the left, a map of a facility at the center, and information about the risk value for the mapped facility at the right. The map of FIG. 8 also includes multiple highlighted sections indicating locations on the map that are particularly prone to (e.g., have a greater likelihood of) the risk and have different risk value ranges. The display of FIG. 8 may correspond to a combined hazard (e.g., total of flammability, thermal radiation, and toxicity).

FIG. 12 illustrates an example network system 1200 in which computerized risk screening may be implemented. As shown, the network system 1200 includes a risk screening computer 1205 connected with multiple facility computers 1215.1-3 via a network 1210. While three facility computers 1215.1-3 are illustrated, the subject technology may be implemented with any number of facilities and facility computers 1215. The network 1210 may include one or more of the Internet, an intranet, a local area network, a wide area network, a wired network, a wireless network, a cellular network, etc. The risk screening computer 1205 and the facility computers 1215.1-3 may include laptop computers, desktop computers, mobile phones, tablet computers, digital music players, smart watches, server computers or any other computing devices having a processor and a memory.

According to some examples, the risk screening computer 1205 requests, via the network 1210, information about facilities from the facility computers 1215.1-3. For example, users of the facility computers 1215.1-3 may be presented with the interfaces of FIG. 4 or FIG. 5 for inputting information about their facilities. Upon receiving the information about the facilities from the facility computers 1215.1-3, the risk screening computer 1205 displays information about the facilities, for example, using displays similar to those presented in FIGS. 2-3 and 6-11. Operations of the risk screening computer 1205 are described in greater detail in conjunction with FIGS. 13-14, below.

In some implementations, a single computer or multiple computers may implement the functionality of the risk screening computer 1205. In some implementations, a single computer or multiple computers may implement the functionality of each facility computer 1215.k, where k is a number between 1 and 3. In some implementations, a single computer may implement the functionality of two or more facility computers 1215.k. In some implementations, as single computer may implement the functionality of the risk screening computer 1205 and one or more risk screening computer(s) 1215.k.

FIG. 13 is a block diagram illustrating the risk screening computer 1205 of FIG. 12 in greater detail. As shown, the risk screening computer 1205 includes a processing unit 1305, a network interface 1310, and a memory 1315. The risk screening computer 1205 is coupled with a display unit 1345, which may include one or more monitors, one or more screens, a projector, etc. The processing unit 1305 includes one or more processors. The processing unit 1305 may include a central processing unit (CPU), a graphics processing unit (GPU), or any other processing unit. The processing unit 1305 executes computer instructions that are stored in a computer-readable medium, for example, the memory 1315. The network interface 1310 allows the risk screening computer 1205 to transmit and receive data in a network, for example, the network 1210 of FIG. 12. The memory 1315 stores data and/or instructions. The memory 1315 may be one or more of a cache unit, a storage unit, an internal memory unit, or an external memory unit. As illustrated, the memory 1315 includes information about facilities 1320.1-3 and a risk screening module 1340. While the memory 1315 is shown as storing information about three facilities 1320.1-3, the memory 1315 may store information about any number of facilities 1320.

When executing the risk screening module 1340, the processing unit 1305 identifies facilities 1320.1-3, which may include one or multiple facilities, for analysis of risk at the facilities 1320.1-3. The processing unit 1305 receives, for each facility 1320.k, a questionnaire answer set 1325.k, which includes answers to questions for analysis of the risk at the facility. The processing unit 1305 determines, for each facility 1320.k, one or more predicted risk level(s) 1330.k at the facility based on the answer set. The processing unit 1305 provides, via the display unit 1345, a visual interface that includes: (i) a list of at least a portion of the facilities 1320.1-3, (ii) a visual representation, for example one or more map(s) 1335.k, of a facility 1320.k from among the facilities 1320.1-3, and (iii) a visual indication (e.g., a highlight or a color code) of the predicted risk level(s) 1330.k for the facility 1320.k associated with the visual representation.

As further shown in FIG. 13, each facility 1320.k stores the questionnaire answer set 1325.k, the predicted risk level(s) 1330.k, and the map(s) 1335.k. The questionnaire answer set 1325.k may be created at the risk screening computer 1205 itself or may be received from the facility computer 1215.k at the corresponding facility. The predicted risk level(s) 1330.k is determined using the risk screening module 1340, as set forth above. The map(s) 1335.k of the facility 1320.k may be received from an online mapping service, from the facility computer 1215.k, or generated locally at the risk screening computer 1205. The map(s) 1335.k may include geographic information about the facility 1320.k. The map(s) 1335.k may also include other information about the facility 1320.k, for example, positions of equipment, real-time positions of moving vehicles, vessels, and/or machinery, etc. In some cases, the map(s) 1335.k may be replaced with any other visual representation (e.g., a photograph or a visual mark) of the facility 1320.k.

FIG. 14 illustrates an example process 1400 by which computerized risk screening may be implemented.

The process 1400 begins at step 1410, where one or more computing devices (e.g., risk screening computer 1205 executing risk screening module 1340) identify multiple facilities (e.g., facilities 1320.1-3) for analysis of risk at each facility in the multiple facilities. The facilities may include factories, shipping ports, military testing facilities, etc.

In step 1420, the one or more computing devices receive, for each facility in the multiple facilities, an answer set to a questionnaire (e.g., questionnaire answer set 1325.k). The answer set includes answers to questions for analysis of risk at the facility.

In step 1430, the one or more computing devices determine, for each facility in the multiple facilities, a predicted risk level of the risk at the facility based on the answer set. The predicted risk level may correspond to an expected value of an event (e.g., $10,000,000 loss due to oil spill) multiplied by a probability of the event (e.g., 1% probability of oil spill).

In some examples, the one or more computing devices may receive, for each facility in the multiple facilities, an input including a list of equipment items at the facility and a failure probability for each equipment item in the list of equipment items. The predicted risk level may be determined based on the failure probability for at least a portion of the equipment items in the list of equipment items. In some examples, equipment items in the list may be associated with geographic locations and may be presented on a map of the facility. Predicted risk levels may be higher near some of the equipment items. For example, a toxicity risk may be higher near a tank storing toxic chemicals.

In some cases, the one or more computing devices may determine, based on a subset of the answer set, a subset of the multiple facilities that are most prone to the risk. The one or more computing devices may provide a visual indication of the subset of the multiple facilities that are most prone to the risk.

In step 1440, the one or more computing device provide a visual interface. The visual interface includes a list of at least a portion of the facilities from among the multiple facilities. The listed portion of the facilities may, in some cases, be equivalent to the subset of the multiple facilities that are most prone to the risk. The visual interface includes a visual representation of at least one facility from among the multiple facilities. The visual interface includes a visual indication of the predicted risk level of the risk for the at least one facility from among the multiple facilities. The visual indication of the predicted risk level may be a color code.

The visual representation of the facility may be a map of the facility. The map may identify (e.g., using various color codes) a degree of susceptibility to the risk of geographic locations within the facility that are shown in the map.

In some cases, the one or more computing devices may further receive a selection of a selected facility from among the listed at least the portion of the facilities. The one or more computing devices may provide a visual representation of the selected facility. The one or more computing devices may provide a visual representation of the predicted risk level at the selected facility.

FIG. 15 conceptually illustrates an electronic system 1500 with which some implementations of the subject technology are implemented. For example, one or more of the risk screening computer 1205 or the facility computers 1215.1-3 may be implemented using the arrangement of the electronic system 1500. The electronic system 1500 can be a computer (e.g., a mobile phone, PDA), or any other sort of electronic device. Such an electronic system includes various types of computer readable media and interfaces for various other types of computer readable media. Electronic system 1500 includes a bus 1505, processor(s) 1510, a system memory 1515, a read-only memory 1520, a permanent storage device 1525, an input device interface 1530, an output device interface 1535, and a network interface 1540. The processor(s) 1510 may include a single processor or may include a processing unit that includes multiple processors.

The bus 1505 collectively represents all system, peripheral, and chipset buses that communicatively connect the numerous internal devices of the electronic system 1500. For instance, the bus 1505 communicatively connects the processor(s) 1510 with the read-only memory 1520, the system memory 1515, and the permanent storage device 1525.

From these various memory units, the processor(s) 1510 retrieves instructions to execute and data to process in order to execute the processes of the subject technology. The processor(s) can be a single processor or a multi-core processor in different implementations.

The read-only-memory (ROM) 1520 stores static data and instructions that are needed by the processor(s) 1510 and other modules of the electronic system. The permanent storage device 1525, on the other hand, is a read-and-write memory device. This device is a non-volatile memory unit that stores instructions and data even when the electronic system 1500 is off. Some implementations of the subject technology use a mass-storage device (for example a magnetic or optical disk and its corresponding disk drive) as the permanent storage device 1525.

Other implementations use a removable storage device (for example a floppy disk, flash drive, and its corresponding disk drive) as the permanent storage device 1525. Like the permanent storage device 1525, the system memory 1515 is a read-and-write memory device. However, unlike storage device 1525, the system memory 1515 is a volatile read-and-write memory, such a random access memory. The system memory 1515 stores some of the instructions and data that the processor needs at runtime. In some implementations, the processes of the subject technology are stored in the system memory 1515, the permanent storage device 1525, or the read-only memory 1520. For example, the various memories include instructions for computerized risk screening in accordance with some implementations. From these various memories, the processor(s) 1510 retrieves instructions to execute and data to process in order to execute the processes of some implementations.

The bus 1505 also connects to the input and output device interfaces 1530 and 1535. The input device interface 1530 enables the user to communicate information and select commands to the electronic system. Input devices used with input device interface 1530 include, for example, alphanumeric keyboards and pointing devices (also called “cursor control devices”). Output device interfaces 1535 enables, for example, the display of images generated by the electronic system 1500. Output devices used with output device interface 1535 include, for example, printers and display devices, for example cathode ray tubes (CRT) or liquid crystal displays (LCD). Some implementations include devices for example a touch screen that functions as both input and output devices.

Finally, as shown in FIG. 15, bus 1505 also couples electronic system 1500 to a network (not shown) through a network interface 1540. In this manner, the electronic system 1500 can be a part of a network of computers (for example a local area network (LAN), a wide area network (WAN), or an Intranet, or a network of networks, for example the Internet. Any or all components of electronic system 1500 can be used in conjunction with the subject technology.

The above-described features and applications can be implemented as software processes that are specified as a set of instructions recorded on a computer readable storage medium (also referred to as computer readable medium). When these instructions are executed by one or more processor(s) (e.g., one or more processors, cores of processors, or other processing units), they cause the processor(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

What is claimed is:

1. A method comprising:
identifying, via one or more computing devices, a plurality of facilities for analysis of risk at each facility in the plurality of facilities;
receiving, at the one or more computing devices, for each facility in the plurality of facilities, an answer set to a questionnaire, the answer set comprising answers to questions for analysis of the risk at the facility;
determining, at the one or more computing devices, for each facility in the plurality of facilities, a predicted risk level of the risk at the facility based on the answer set; and
providing, via the one or more computing devices, a visual interface comprising:
a list of at least a portion of the facilities from among the plurality of facilities,
a visual representation of at least one facility from among the plurality of facilities, and
a visual indication of the predicted risk level of the risk for the at least one facility from among the plurality of facilities.

2. The method of claim 1, wherein the risk comprises one or more of a safety risk, an environmental impact risk, an asset damage risk, a business loss risk, a public image risk, or a public notification risk.

3. The method of claim 1, wherein the visual representation of the at least one facility comprises a map of the at least one facility, and wherein the map identifies a degree of susceptibility to the risk of geographic locations within the at least one facility that are shown on the map.

4. The method of claim 3, wherein the map identifies, using various color codes, the degree of susceptibility to the risk of the geographic locations.

5. The method of claim 1, further comprising:
receiving a selection of a selected facility from among the listed at least the portion of the facilities;
providing a visual representation of the selected facility; and
providing a visual indication of the predicted risk level of the risk for the selected facility.

6. The method of claim 1, further comprising:
determining, based on a subset of the answer set, a subset of the plurality of facilities that are most prone to the risk; and
providing a visual indication of the subset of the plurality of facilities that are most prone to the risk.

7. The method of claim 6, wherein the at least the portion of the facilities listed in the visual interface is equivalent to the subset of the plurality of facilities that are most prone to the risk.

8. The method of claim 1, wherein the visual indication of the predicted risk level of the risk for the at least one facility comprises a color code.

9. The method of claim 1, further comprising:
receiving, for each facility in the plurality of facilities, an input comprising a list of equipment items at the facility and a failure probability for each equipment item in the list of equipment items, wherein the predicted risk level is determined based on the failure probability for at least a portion of the equipment items in the list of equipment items.

10. The method of claim 1, wherein the predicted risk level is determined based on an expected value of an event associated with the risk multiplied by a probability of the event.

11. A non-transitory computer-readable medium comprising instructions which, when executed by one or more computers, cause the one or more computers to:
identify a plurality of facilities for analysis of risk at each facility in the plurality of facilities;
receive, for each facility in the plurality of facilities, an answer set to a questionnaire, the answer set comprising answers to questions for analysis of the risk at the facility;
determine, for each facility in the plurality of facilities, a predicted risk level of the risk at the facility based on the answer set; and
provide a visual interface comprising:
a list of at least a portion of the facilities from among the plurality of facilities,
a visual representation of at least one facility from among the plurality of facilities, and
a visual indication of the predicted risk level of the risk for the at least one facility from among the plurality of facilities.

12. The computer-readable medium of claim 11, wherein the risk comprises one or more of a safety risk, an environmental impact risk, an asset damage risk, a business loss risk, a public image risk, or a public notification risk.

13. The computer-readable medium of claim 11, wherein the visual representation of the at least one facility comprises a map of the at least one facility, and wherein the map identifies a degree of susceptibility to the risk of geographic locations within the at least one facility that are shown on the map.

14. The computer-readable medium of claim 13, wherein the map identifies, using various color codes, the degree of susceptibility to the risk of the geographic locations.

15. The computer-readable medium of claim 11, further comprising instructions which, when executed by the one or more computers, cause the one or more computers to:
receive a selection of a selected facility from among the listed at least the portion of the facilities;
provide a visual representation of the selected facility; and
provide a visual indication of the predicted risk level of the risk for the selected facility.

16. The computer-readable medium of claim 11, further comprising instructions which, when executed by the one or more computers, cause the one or more computers to:
determine, based on a subset of the answer set, a subset of the plurality of facilities that are most prone to the risk; and
provide a visual indication of the subset of the plurality of facilities that are most prone to the risk.

17. The method of claim 6, wherein the at least the portion of the facilities listed in the visual interface is equivalent to the subset of the plurality of facilities that are most prone to the risk.

18. The computer-readable medium of claim 11, wherein the visual indication of the predicted risk level of the risk for the at least one facility comprises a color code.

19. A system comprising:
one or more processors; and
a memory comprising instructions which, when executed by the one or more processors, cause the one or more processors to:
identify a plurality of facilities for analysis of risk at each facility in the plurality of facilities;
receive, for each facility in the plurality of facilities, an answer set to a questionnaire, the answer set comprising answers to questions for analysis of the risk at the facility;
determine, for each facility in the plurality of facilities, a predicted risk level of the risk at the facility based on the answer set; and
provide a visual interface comprising:
a list of at least a portion of the facilities from among the plurality of facilities,
a visual representation of at least one facility from among the plurality of facilities, and
a visual indication of the predicted risk level of the risk for the at least one facility from among the plurality of facilities.

20. The system of claim 19, wherein the risk comprises one or more of a safety risk, an environmental impact risk, an asset damage risk, a business loss risk, a public image risk, or a public notification risk.
